(19) United States
(12) Patent Application Publication
(10) Pub. No.: US 2022/0184706 A1
(43) Pub. Date: Jun. 16, 2022

(54) IMPROVED CORROSION RESISTANCE OF ADDITIVELY-MANUFACTURED ZIRCONIUM ALLOYS

(71) Applicant: Westinghouse Electric Company LLC, Cranberry Township, PA (US)

(72) Inventors: Jonna Partezana MUNDORFF, Finleyville, PA (US); William T. CLEARY, Irmo, SC (US); Magnus LIMBACK, Västerås (SE); Andrew J. MUELLER, Blythewood, SC (US); Robert J. COMSTOCK, Irwin, PA (US)

(73) Assignee: Westinghouse Electric Company LLC, Cranberry Township, PA (US)

(21) Appl. No.: 17/594,803

(22) PCT Filed: Apr. 23, 2020
(86) PCT No.: PCT/US2020/029539

§ 371 Date: Oct. 29, 2021

Related U.S. Application Data
(60) Provisional application No. 62/841,067, filed on Apr. 30, 2019.

(51) Int. Cl. B22F 10/64; B22F 10/28; B33Y 10/00; B33Y 40/20; B33Y 70/00; C22F 1/18

(52) U.S. Cl. CPC B22F 10/64; B22F 10/28; B33Y 10/00; B22F 2301/205; B33Y 70/00; C22F 1/186; B33Y 40/20

(57) ABSTRACT

A process is described that includes forming a metal alloy component having a pre-specified three dimensional geometry for use in a nuclear reactor by an additive manufacturing process followed by annealing the formed component at a first annealing temperature within the alpha temperature range of the phase diagram for the metal alloy. A second annealing step at a second annealing temperature lower than the first annealing temperature may be added. Alternatively, annealing may be at an annealing temperature in the alpha+beta temperature range of a phase diagram for the metal alloy, followed by a second anneal in the alpha temperature range of the phase diagram for the metal alloy.

### CROSS-REFERENCE

This application claims priority to U.S. Provisional Patent Application No. 62/841,067, which was filed on Apr. 30, 2019. The contents of which is incorporated by reference into this specification.

### FIELD

This invention relates to an additive manufacturing process for making components for use in a nuclear reactor, and more particularly, to process including annealing the component following additive manufacturing.

### BACKGROUND

Additive manufacturing (AM) (i.e., 3D printing) is an enabling technology for novel designs and complex shapes that cannot easily be produced using traditional manufacturing methods. In 2010, the American Society for Testing and Materials (ASTM) grouped AM processes into seven categories in a new standard—“ASTM F42—Additive Manufacturing.” The current categories of additive manufacturing processes are: powder bed fusion, vat photo-polymerization, binder jetting, material extrusion, directed energy deposition, material jetting, and sheet lamination. These seven additive manufacturing processes include notable variations on the layered 3D printing concept. Material state (powder, liquid, filament), heat or light sources (laser, thermal, electron beam, plasma arc), number of print axes, feed systems and build chamber characteristics all vary.

Although additive manufacturing technologies have the ability to produce unique geometries that offer substantial performance benefits, there are challenges that hinder the nuclear industry from taking full advantage of these unique additive manufacturing capabilities. For example, there is limited, if any, data available on the impact of neutron irradiation exposure on additively manufactured zirconium material properties.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, and abstract as a whole.

In one general aspect, the present disclosure provides a method for additively manufacturing a component for use in a nuclear reactor. The method comprises additively manufacturing the component for use in the nuclear reactor utilizing a feedstock comprising a metal. The method comprises annealing the additively manufactured component at a first annealing temperature within the alpha phase temperature range of the metal, the alpha+beta phase temperature range of the metal, or a combination thereof

In another general aspect the present disclosure provides a method for additively manufacturing a component for use in a nuclear reactor. The method comprises depositing a layer of a powder feedstock comprising a zirconium alloy, across a build plate; at least a selected region of the layer is affixed together in the selected region. The affixing comprises rastering a laser across the layer of powder feedstock along a path guided by previously input computer-aided design files of the specifications for a three-dimensional component to be built, melting the powder feedstock within the layer with the laser, and solidifying the melted powder. The depositing and the affixing are repeated to provide an additively manufactured component. The additively manufactured component is removed from the build plate. The additively manufactured component is annealed at an annealing temperature within the alpha phase temperature range of the metal, the alpha-beta phase temperature range of the metal, or a combination thereof.

### BRIEF DESCRIPTION OF THE DRAWINGS

The characteristics and advantages of the present disclosure may be better understood by reference to the accompanying Figures.

FIGS. 1A-1D illustrates representative images of the Zircaloy-2 powder used to print the additively manufactured block by Laser Powder Bed Fusion. Note that both spherical and angular particles make up the powder geometry. Images courtesy of ATI Specialty Alloys and Components, the source of the powder used in experiments described herein.

FIG. 2A illustrates the top surface during the build-up process.

FIG. 2B illustrates the final additively manufactured Zircaloy-2 block on build plate (B, right image).

FIG. 3 illustrates an embodiment of a spacer grid formed from grid straps welded together, as shown in the inset.

FIGS. 4A-4C are optical micrographs of as-polished sections of additively manufactured Zircaloy-2 in three different orthogonal directions. The build direction is along the Z axis.

FIGS. 5A-5C are SEM micrographs of irregularly-shaped and spherical voids in additively manufactured Zircaloy-2.

FIGS. 6A-6B are light optical micrographs of the additively manufactured Zircaloy-2 microstructure.

FIGS. 6C-6D are SEM micrographs of the additively manufactured Zircaloy-2 microstructure.

FIG. 7A is an SEM micrograph of cross section of irradiated quad of additively manufactured Zircaloy-2 including the oxide layer and hydrides following irradiation of 0.9 dpa.

FIG. 7B is an SEM micrograph of a cross section of irradiated quad of additively manufactured Zircaloy-2 including the oxide layer and hydrides following irradiation of 1.6 dpa.

FIG. 8A is a light optical polarized micrograph of the additively manufactured Zircaloy-2 sample, polished but without annealing under polarized light.

FIG. 8B is a light optical polarized micrograph of the additively manufactured Zircaloy-2 sample, polished but without annealing under polarized light.

FIG. 9A is light optical polarized micrographs of additively manufactured Zircaloy-2 samples, following 2 h anneal at 760° C.

FIG. 9B is light optical polarized micrographs of additively manufactured Zircaloy-2 samples, following 2 h anneal at 760° C.

FIG. 10 is a phase diagram for the binary system of Fe—Zr as published in Metals Handbook, vol. 8: Metallography, Structures and Phase Diagrams, American Society for Metals, Metals Park, Ohio 1973.

FIG. 11 is a phase diagram for the binary system of Sn—Zr as published in Metals Handbook, vol. 8: Metallography, Structures and Phase Diagrams, American Society for Metals, Metals Park, Ohio 1973.

FIG. 12 is a phase diagram for the binary system of Cr—Zr as published in Metals Handbook, vol. 8: Metallography, Structures and Phase Diagrams, American Society for Metals, Metals Park, Ohio 1973.

FIG. 13A is a measured pole figured of additively manufactured Zircaloy-2 material.

FIG. 13B is a calculated pole figured of additively manufactured Zircaloy-2 material.

FIG. 14A is a scanning electron micrograph of oxide layers formed on autoclave corrosion samples of additively manufactured Zircaloy-2 as-fabricated after 9 days of exposure in 427° C. steam.

FIG. 14B is a scanning electron micrograph of oxide layers formed on autoclave corrosion samples of additively manufactured Zircaloy-2 including an anneal for 2 h at 760° C. after 9 days of exposure in 427° C. steam.

FIG. 15A is a SEM micrograph of a fracture surface of a tensile Room Temperature (RT) test sample of unirradiated fully recrystallized (RXA) Zircaloy-2.

FIG. 15B is a SEM micrograph of a fracture surface of a tensile RT test sample of unirradiated AM Zircaloy-2.

FIG. 15C is a SEM micrograph of a fracture surface of a tensile 573° K test sample of unirradiated fully recrystallized (RXA) Zircaloy-2.

FIG. 15D is a SEM micrograph of a fracture surface of a tensile 573° K test sample of unirradiated AM Zircaloy-2.

FIG. 16A is a SEM micrograph of a fracture surface of a tensile RT test sample of irradiated 0.9 dpa AM Zircaloy-2 sample.

FIG. 16B is a SEM micrograph of a fracture surface of a tensile RT test sample of irradiated 1.6 dpa AM Zircaloy-2.

FIG. 16C is a SEM micrograph of a fracture surface of a tensile 573° K test sample of irradiated 0.9 dpa of AM Zircaloy-2.

FIG. 16D is a SEM micrograph of a fracture surface of a tensile 573° K test sample of irradiated 1.6 dpa AM Zircaloy-2.

### DESCRIPTION OF THE PREFERRED EMBODIMENTS

As used herein, the singular form of “a”, “an”, and “the” include the plural references unless the context clearly dictates otherwise. Thus, the articles “a” and “an” are used herein to refer to one or to more than one (i.e., to at least one) of the grammatical object of the article. By way of example, “an element” means one element or more than one element.

In the present application, including the claims, other than where otherwise indicated, all numbers expressing quantities, values or characteristics are to be understood as being modified in all instances by the term “about.” Thus, numbers may be read as if preceded by the word “about” even though the term “about” may not expressly appear with the number. Accordingly, unless indicated to the contrary, any numerical parameters set forth in the following description may vary depending on the desired properties one seeks to obtain in the compositions and methods according to the present disclosure. At the very least, and not as an attempt to limit the application of the doctrine of equivalents to the scope of the claims, each numerical parameter described in the present description should at least be construed in light of the number of reported significant digits and by applying ordinary rounding techniques.

Further, any numerical range recited herein is intended to include all sub-ranges subsumed therein. For example, a range of “1 to 10” is intended to include any and all sub-ranges between (and including) the recited minimum value of 1 and the recited maximum value of 10, that is, having a minimum value equal to or greater than 1 and a maximum value of equal to or less than 10.

The components of a nuclear reactor would benefit from the use of additive manufacturing processes, especially when the material properties are improved to enhance corrosion resistance. It has been unexpectedly discovered that fully recrystallized alloys are produced by applying a high temperature anneal after printing a component when the temperature range of the anneal is within one of the alpha temperature range or the alpha+beta temperature range of a phase diagram for the selected metal. The high temperature anneal also nucleates and coarsens the second phase particles (SPPs) of the alloy.

The present disclosure provides a method for additively manufacturing a component for use in a nuclear reactor (e.g., light water reactor or small modular reactor) wherein the component can be fully recrystallized and/or have enhance corrosion resistance. The component can comprise a debris filter, an intermediate flow mixer, or a spacer grid, or a combination thereof. Components produced according to the present disclosure can comprise improved heat transfer and thermal hydraulic performance.

The method comprises additively manufacturing a component for use in the nuclear reactor utilizing a feedstock comprising a metal comprising a zirconium alloy. The feedstock can comprise powder, a sheet, or a wire, or a combination thereof. In examples, where the feedstock comprises powder, the powder feedstock can comprise a mean average particle size in a range of 10 micrometers to 100 micrometers, such as, for example, 40 micrometers to 80 micrometers. The particle size can be measured by a scanning electron microscope, a transmission electron microscope, sieve screens, or laser diffraction. It is believed smaller or larger particle sizes may be used as well. The additive manufacturing process can comprise powder bed fusion, vat photo-polymerization, binder jetting, material extrusion, directed energy deposition, material jetting, or sheet lamination, or a combination thereof.

The metal can comprise a zirconium alloy. For example, the metal can comprise Zircaloy-2, Zircaloy-4, HiFi™, a binary zirconium alloy, and a non-binary zirconium alloy comprising tin and another alloying element, ZIRLO, Optimized ZIRLO, AXIOM, a non-binary zirconium alloy comprising niobium and another alloying element, or a combination thereof. In some examples, the zirconium alloy can comprise niobium, such as, for example, a binary zirconium alloy comprising niobium (e.g., Zr-1Nb, Zr-2.5Nb, M5, E110) or a non-binary zirconium alloy comprising niobium and another alloying element. Various zirconium alloys may be used in nuclear reactor applications due to the low neutron cross section, relatively good corrosion resistance, and desired mechanical properties of the various zirconium alloys.

Additive manufacturing can comprise generating a computer-aided-design (CAD) file for the desired component geometry, inputting the CAD file into an additive manufacturing system, and introducing a desired feedstock to the additive manufacturing system. In examples where the additively manufacturing comprises powder bed fusion with a laser, the additive manufacturing can comprise depositing a layer of a powder feedstock comprising a metal, across a build plate of an additive manufacturing system. At least a selected region of the layer can be affixed together in the selected region utilizing a laser of the additive manufacturing system. For example, the laser can be rastered across the layer of powder feedstock along a path guided by computer-aided design file for a three-dimensional component to be built. The computer-aided design file can be input to a computer controlling the additive manufacturing system prior to the start of the component build process. The powder feedstock within the layer can be melted by the laser. Thereafter, the laser can be removed from the selected region of the layer and the melted powder can solidify. The depositing of the powder feedstock and the affixing with the laser can be repeated to provide an additively manufactured component. The additively manufactured component from the build plate.

Thereafter, the additively manufactured component can be annealed at a first annealing temperature within the alpha phase temperature range, or the alpha+beta phase temperature range of the metal, or a combination thereof for a time period. In various examples, the annealed additively manufactured component can be annealed for a second time at a second annealing temperature. For example, the additively manufactured component can be heated to the first annealing temperature for a first time period and decreased to a second temperature and held at the second temperature for a second time period. After the second time period and any optional subsequent time periods, the temperature is decreased to room temperature to complete the annealing.

In various examples, the first annealing temperature may be in the alpha phase temperature range of the metal which can facilitate recrystallization of the microstructure and can be followed by an optional second annealing temperature also in the alpha phase temperature range of the metal but at a lower temperature to limit grain growth. This approach may provide flexibility in tailoring an appropriate annealing for additively manufactured components. In other examples, the first annealing temperature can be in the alpha+beta phase temperature range of the metal which can facilitate recrystallize of the microstructure and the second annealing temperature can be within the alpha phase temperature range of the metal which can improve the size and distribution of second-phase particles. For example, an anneal in the alpha+beta phase temperature range followed by an anneal in the alpha phase temperature range may be beneficial for a zirconium alloy that comprises niobium.

In various examples, the first annealing temperature can be within the alpha phase temperature range of the metal and the second annealing temperature can be within the alpha+beta phase temperature range of the metal. The second annealing temperature can be lower than the first annealing temperature. For example, the first annealing temperature can be in a range of 450° C. to 800° C., such as, for example 600° C. to 800° C., 700° C. to 800° C., 740° C. to 780° C., 450° C. to 600° C., 530° C. to 580° C., or 450° C. to 620° C. In various examples, the first annealing temperature is 760° C. The second annealing temperature can be in a range of 450° C. to 620° C., such as, for example, 530° C. to 580° C. or 450° C. to 600° C. The annealing can recrystallize a microstructure of the additively manufactured component such that the component is suitable for use in a nuclear reactor.

In various examples wherein the metal comprises a niobium alloy comprising zirconium, the first annealing temperature is in a range of 600° C. to 800° C. and the second annealing temperature is in a range of 450° C. to 600° C., 450° C. to 620° C., or 530-580° C. In various examples, the first annealing temperature and first time period can facilitate recrystallization and the second annealing temperature and second time period can enable SPPs of the desirable composition and size distribution for a nuclear component. For example, the metal can comprise an alloy comprising a matrix of a primary phase metal and a second-phase metal, and the second annealing temperature achieves a desirable composition and size distribution for the second-phase metal. In examples where the metal comprises a zirconium alloy comprising niobium, the second annealing temperature and second time period can ensure that that β-zirconium is transformed to β-niobium (and α-zirconium) and thereby improves the corrosion properties (increases the resistance against oxidation and hydrogen pickup).

The additively manufactured component can be annealed be for a total time period in a range of 0.1 hour to 100 hours, such as, for example, 0.1 hour to 10 hours or 1 hours to 3 hours. For example, the first time period can be in a range of 0.1 hour to 100 hours, such as, for example, 0.1 hour to 10 hours or 1 hours to 3 hours. In some examples, the first time period can be 2 hours.

Electron beam melting is an example of an additive manufacturing technology that can create metal components. This method uses metal powder, which is melted by an electron beam. The powder is usually melted in a vacuum, and forms three-dimensional shapes layer by layer. Another type of additive manufacturing makes use of lasers to melt metal into a desired three-dimensional shape. This technology typically involves using a laser to heat metal into a molten pool, after which additional metal is added in a layer-wise fashion. The laser again moves across the surface of either the powder bed or component as new material is added, so that the desired object is produced.

Zirconium alloys can contain a primary metal that forms a matrix phase with second-phase particles dispersed throughout the matrix. Before obtaining a finished product, several thermomechanical processing steps can occur, during which recrystallization occurs and second-phase particles (SPPs) nucleate and coarsen. The second-phase particles may retard or accelerate recrystallization, depending on factors such as size and spatial distribution of the particles, and processing conditions. The SPPs size distribution, furthermore, can affect the corrosion and hydrogen pickup resistance of the final product. Since the microstructure of additively manufactured materials can be significantly different from conventionally-processed materials in terms of grain size and shape, texture, precipitate types and composition as well as precipitate size distribution, the irradiation response of additively manufactured components of alloys commonly used in nuclear reactors may have to be directly tested to determine if the additively manufactured material behaves differently from current conventional materials.

Zirconium alloys are conventionally used for various components in nuclear reactors. A typical composition of nuclear-grade zirconium alloys is more than 95 wt. % zirconium and typically less than 3 wt. % of one or more of tin, niobium, iron, chromium, nickel and other metals, which are added to improve mechanical properties and corrosion resistance. For example, zirconium alloys known as Zircaloy-2 and Zircaloy-4 include about 98 wt. % zirconium and from 1.2 to 1.7 wt. % tin, and smaller amounts of chromium and iron, but no niobium. Zircaloy-2 and HiFi™ also include nickel. HiFi™ is another alloy like Zircaloy-2 that contains higher concentrations of iron (0.4 wt.%). Zirconium alloya sold under the trademark names ZIRLO® and Optimized ZIRLO™ have between about 0.6-1.1 wt. % tin, 0.8-1.2 wt% niobium, and 0.09-0.13 wt% iron, with the balance being zirconium. AXIOM® is another zirconium-based alloy containing lesser amounts of niobium, tin, iron, copper and vanadium. The nominal ranges for AXIOM® are 0.7-1.0 wt.%, Nb, 0.3-0.4 wt. % Sn, 0.05-0.1 wt. % Fe, 0.1-0.2 wt. % Cu and 0.2-0.3 wt. % V. Zircaloy-4, ZIRLO®, and AXIOM® alloys are nickel-free. One of the challenges for using zirconium materials for nuclear applications is achieving acceptable corrosion behavior, while maintaining sufficiently good mechanical properties.

Due to the rapid cooling of the melt pool during various additive manufacturing processes and the metal powders that are used, the alloy additions may remain in solution or form very fine second phase particles. Both conditions can be detrimental for in-reactor corrosion. The additive manufacturing process methodology may not produce a microstructure optimized for corrosion resistance.

Conventional processing of zirconium-based alloys can typically include beta forging of the ingot, beta quenching, hot working, multiple iterations of alpha annealing and cold working to final size followed by a final anneal [1].

“Beta quenched” as used herein means cooled from the beta-phase (body-centered cubic crystal structure). The transformation from beta to alpha results in a lathe type structure where the lathes are alpha (hexagonal close-packed crystal structure). At high cooling rates (greater than 500° C. per second), the alpha phase is slightly distorted and commonly referred to as martensitic.

Annealing is a heat treatment that alters the physical and sometimes the chemical properties of a material to increase its ductility and reduce its hardness to make it more workable. In typical annealing processes, a material is heated above its recrystallization temperature, held at or near that temperature for a period of time, and then cooled.

Additive manufacturing is a significant departure from conventional processing. Unlike conventional processing, additive manufacturing can produce the final size component directly from the starting material. While other additive manufacturing methods may be used, laser powder bed fusion (LPBF) can be used when the starting material was powder. The laser locally melts the powder resulting in a beta-quenched microstructure upon cooling from the melt. An advantage of additive manufacturing can be the ability to produce final sized components with complex geometries. However, that advantage may preclude further mechanical working of the component and limit post additive manufacturing processing to thermal treatments.

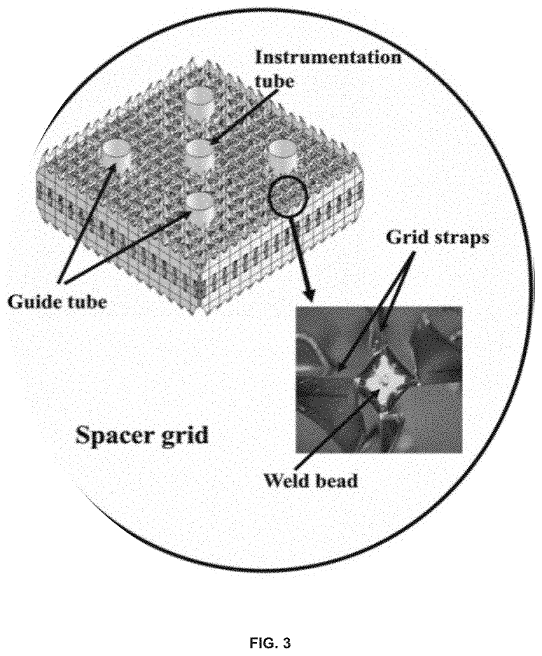

Nuclear reactor component designs are limited by conventional manufacturing techniques. By way of example, spacer grids can be typically fabricated by welding together stamped grid straps, as shown in the inset in FIG. 3, to form a grid which becomes part of a nuclear fuel rod assembly. In order to produce any such components additively, the material properties of the resulting components need to be comparable or better than the properties of materials resulting from conventional processes. The process described herein can improve the performance of additively printed zirconium alloy materials sufficiently to make additive manufacture of such components acceptable. Today's standard processing, with multiple iterations of alpha annealing and cold working to final size followed by a final anneal, can provide a preferred texture of the final product. One feature of additively manufactured processed Zr-based alloys can be a randomized final crystal structure which decreases the irradiation induced growth of the component.

The inventors have found a fully recrystallized microstructure following a high temperature alpha anneal of the additively manufactured Zircaloy-2 material according to the process herein can be advantageous. This anneal can be performed to nucleate and coarsen second phase particles, but the unexpected result was a full recrystallization of the material. Typically, β-annealed zirconium alloys do not recrystallize during subsequent α-annealing. However, we believe the recrystallization occurs due to the quenching strain in the additively manufactured material and a high annealing temperature (e.g., 750° C.). In preliminary testing, the additively manufactured material exhibited corrosion properties similar to those of conventional Zircaloy-2. Based upon the presence of a random texture in the printed additively manufactured material, it is expected that the texture of the annealed additively manufactured material will be random, resulting in low in-reactor irradiation induced growth.

The process described herein can make unique geometries that can improve performance of the fuel assemblies to be used in nuclear reactors. The process described herein can enable alternative design and production methods for nuclear reactor components, such as fuel assembly grid designs, which may enhance thermo-hydraulic performance of the fuel assemblies.

Another challenge for additive manufacturing of components for use in nuclear reactors, for example, zirconium alloys, can be achieving acceptable corrosion behavior from 3D printing alone.

There may be a limited opportunity for achieving an optimized microstructure for corrosion alone. However, by annealing the material, after printing, in the high temperature alpha region as shown in the phase diagram of the selected alloy to nucleate and coarsen second phase particles (SPPs), a fully recrystallized microstructure for the alloy that has to date been shown to withstand corrosion can be produced. Coarsening the second phase particles addresses the problem from having very fine SPP sizes, which have been found to be detrimental for in-reactor corrosion performance. “Very fine” as used herein means at or below 40 nanometers. Particles equal to or less than 40 nm are too small in Zircaloy-2 alloy. Particles of this size dissolve in Zircaloy-2 when irradiated and compromise corrosion-resistance.

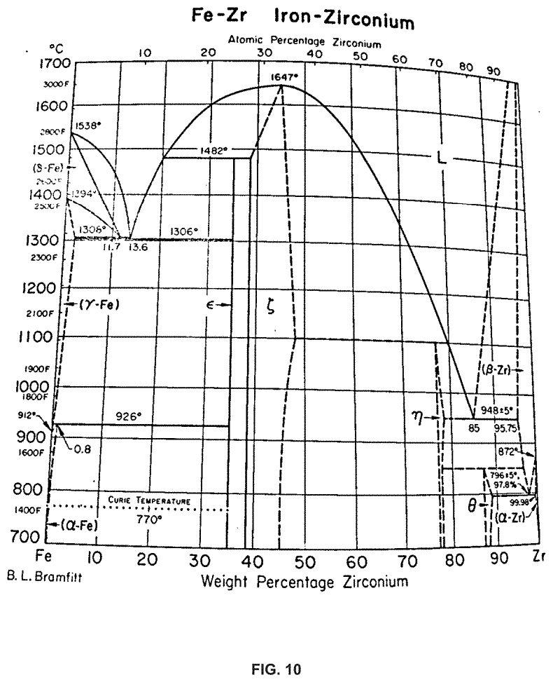

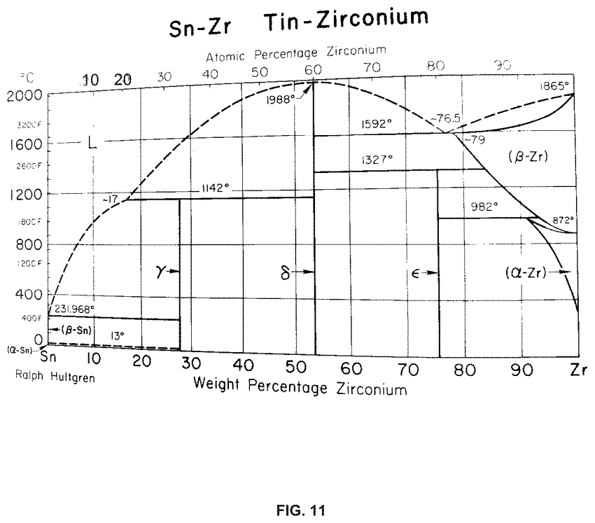

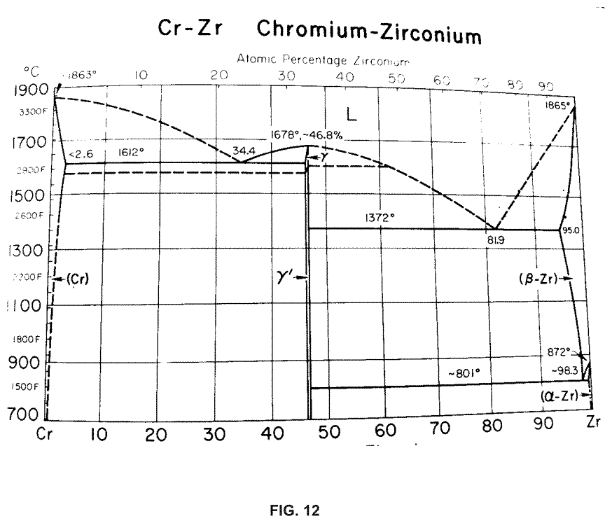

A phase is the crystallographic structure of the metal at a given temperature range. The alpha range is below 815° C. for Zircaloy-2 (See FIGS. 10-12). This temperature can go up or down depending upon any alloy additions or impurities. These additions can form tiny regions rich in an element(s) within the microstructure of the zirconium. Typically, the regions can form tiny particulates in the material. A grain is a microstructural feature that affects the performance of a metal or material. A boundary is the interface between two or more grains. The particulates, referred to as second phase particles, can look like little dots in the micrographs among the larger block-like grains. The impurities or alloying additions can help to get second phase particles to nucleate.

A desirable microstructure can be one that has grains that are similar in size and equiaxed (i.e., no longer in one specific direction). Zirconium alloys usually tend towards a small grain size (˜ASTM grain size 10 or smaller.) In order to achieve this, multiple steps of cold working (e.g., pilgering or rolling for Zr alloys) and anneals can be performed. This multi-step process can be followed for conventionally-processed zirconium alloys. This process can help break up the as-cast structure.

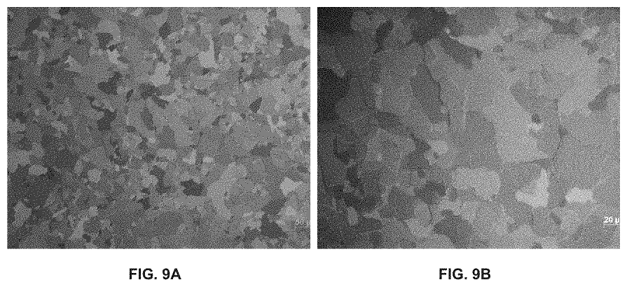

An alpha anneal at 760° C. for two hours was applied to additively manufactured Zircaloy-2 material and then samples were tested in a short-term steam autoclave (427° C./1500 psi for 9 days). Weight gains after short-term autoclave testing were measured and the gains were comparable to conventional Zircaloy-2 materials as shown in Table 1 below. Samples were then metallography examined and shown to result in a fully recrystallized microstructure (FIGS. 9A and 9B). The resultant microstructure makes additively manufactured Zr material closer to conventionally-processed material; more desirable microstructure but in a geometry that is not easily achieved by conventional machining techniques. Traditionally, zirconium will not recrystallize without cold work based on stresses that are placed into the material. In the additively manufactured material, the needed stresses are hypothesized to have come from the rapid quenching during additively manufactured fabrication. In addition, it is expected that the recrystallized microstructure will have random texture which can minimize in-reactor irradiation growth.

In various aspects, additive manufacturing may be applied to other zirconium-based alloy compositions. Zr—Nb based alloys, for example, are another class of alloys that would benefit from processes for obtaining acceptable corrosion properties within additive manufacturing. Zr—Nb second phase particles (β-Nb) behave differently under irradiation than second phase particles in Zircaloys. Beta-niobium particles are generally smaller (˜20 nm in size) and more resistant against irradiation induced amorphisation and dissolution than SPPs in the Zircaloys.

Preferred annealing temperatures for use in the process can be in the range 450 to 800° C. for Zircaloys (Zircaloy-2 and Zircaloy-4 based alloys) and 450 to 620° C. for Nb containing Zr-based alloys, such as binary Zr—Nb alloys, ZIRLO, Optimized ZIRLO, AXIOM, and other alloys that contain Nb and lower the α to α+β phase transformation temperature.

The preferred annealing temperature for the additively manufactured material can be in the alpha range, and preferably high in the alpha range, where that range is alloy dependent. See (Tong, V. S. and T. B. Britton, “Formation of very large ‘blocky alpha’ grains in Zircaloy-4”, Acta Materialia, 129 (2017) 510-520; and D. F. Washburn, “The formation of large grains in alpha Zircaloy-4 during heat treatment after small plastic deformations,” Knolls Atomic Power Laboratory, General Electric Company, Report KAPL-3062, New York, 1964) where recrystallization following low amounts of deformation is shown to have occurred only high in the alpha temperature range. In the process described herein, recrystallization after annealing high in the alpha range is shown but on a quenched component with no deformation.

### EXAMPLES

TABLE 1
Autoclave Test Results (427° C./1500 psi steam)

| | | | | H Pickup | |
|---|---|---|---|---|---|
| | | | | (WPPM) | |
| | | | | normalized | |
| | | | | to 0.5 mm | |
| | | | Weight | thick | |
| | | Time | Gain | sample | H Pickup |
| Material | Process | (days) | (mg/dm²) | Norm. | % theoretical |
| Additively | as-processed | 9 | 130 | 260 | 24 |
| Manufactured | | | 159 | — | — |
| Zircaloy-2 | 760° C./2 h | | 50 | 98 | 24 |
| | | | 52 | — | — |
| Zircaloy-2 | RXA/ATI | 10 | 42 | — | — |
| Plate | | | 40 | — | — |
| | RXA/ | | 47 | — | — |
| | Sandvik | | 46 | — | — |
| | FDBQ/ | | 58 | — | — |
| | Sandvik | | 57 | — | — |

In a first set of experiments, a block of additively manufactured material was produced by laser powder bed fusion using a commercially available industrial 3D printer with the starting material being Zircaloy-2 powder. Goals of the study were to demonstrate the following:
Achieve near theoretical density in additively manufactured Zircaloy-2 material from the starting powder.
No significant chemistry changes between starting powder and resulting block. The potential concern was depletion of alloying elements and pickup of oxygen and nitrogen during laser melting of the powder.
Maintain acceptable mechanical properties in the as-fabricated additively manufactured condition as well as after short term irradiation (up to 1.6 dpa).
Assess the corrosion behavior of the additively manufactured as-fabricated material and identify options for corrosion improvement.

The results of this preliminary assessment of an additively manufactured zirconium alloy are presented below along with an assessment of the technical challenges that need to be resolved prior to the application of additive manufacturing for light water reactor zirconium alloy components.

Experimental

### Laser Powder Bed Fusion

Laser Powder Bed Fusion (LPBF) is an additive-manufacturing technique that uses a laser to melt and fuse powder together. Since zirconium is a highly reactive metal in its molten state and its powder is pyrophoric, an inert atmosphere or high vacuum system is required for safety [2]. A thin layer of power is spread across a build plate and a laser is rastered across the plate as guided by the computer-aided design (CAD) file with the specifications for the three-dimensional (3D) component to be built previously input. The powder melts under the laser power and quickly solidifies [2]. Another layer of fresh powder is then distributed across the freshly built layer and the process is repeated within the build chamber. This layer-by-layer deposition is built up in the z-axis direction until the 3D component is completed. Loose, unbonded material is then removed from the component and the part is cut away from the build plate.

Zircaloy-2 Materials

### Powder

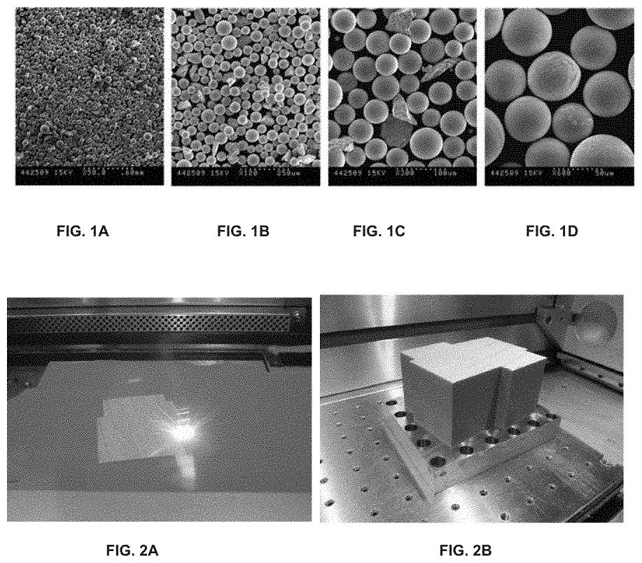

A block of additively-manufactured Zircaloy-2 was produced by laser powder bed fusion (LPBF) using an EOS industrial 3D metal printer (model EOS M280). Zircaloy-2 powder was selected as the source material for the 3D printing as it was readily available from ATI Specialty Alloys & Components. The powder was initially produced by the hydride/dehydride (HDH) process and sieved to control particle size. The sieved powder was then put through a plasma spheroidization process to achieve the desired shape and flow characteristics for printing. Many of the particles were made to be spherical in shape; however, angular particles still remained. Images of the powder are provided in FIGS. 1A-1D. The powder size ranged from 40 to 60 micrometers and the powder chemistry is reported in Table 2.

TABLE 2
Composition of Zircaloy-2 Materials

| | | Composition | | | | | | |
|---|---|---|---|---|---|---|---|---|
| | | Weight Percent | | | | | wPPM | |
| Sample | Process | Sn | Fe | Cr | Ni | O | N | H |
| Zircaloy-2 | HDH | 1.41 | 0.126 | 0.086 | 0.052 | 0.16 | 110 | — |
| powder (ATI) | | | | | | | | |
| Additive | Additive | 1.38 | 0.128 | 0.079 | 0.052 | 0.17 | 85 | 33 |
| Manufacturing | Manufacturing | | | | | | | |
| Zircaloy-2 | | | | | | | | |
| block (EWI) | | | | | | | | |
| Zircaloy-2 | RXA | 1.52 | 0.188 | 0.104 | 0.074 | 0.12 | 22 | 4 |
| plate (ATI) | | | | | | | | |
| Zircaloy-2 | RXA | 1.35 | 0.168 | 0.104 | 0.066 | 0.12 | 20 | <3 |
| plate | BQ | 1.36 | 0.180 | 0.108 | 0.070 | 0.13 | 29 | 3 |
| (Sandvik) | | | | | | | | |
| ASTM | — | 1.2-1.7 | 0.07-0.20 | 0.05-0.15 | 0.03-0.08 | ¹ | 80 | 25 |
| B352 | | | | | | | max | max |
| Zircaloy-2 | | | | | | | | |

¹ Oxygen content specified by the customer in the purchase order.

Additively-Manufactured Build Block

The additively manufactured block geometry is shown in FIG. 2B with nominal dimensions in the X-Y plane of 100 mm×78 mm. The height of the block (Z plane, or build direction) was about 50 mm. The block was formed by laser fusing successive thin layers (40 micrometers) of Zircaloy-2 powder as shown in FIG. 2A. Because of the printing process used, it was expected that the X and Y directions would be essentially identical in terms of microstructure and mechanical properties. The printing parameters were developed to provide optimum density of the build structure and select details are provided in Table 3. Chemistry of the as-printed block is given in Table 2 along with the ASTM elemental ranges for Zircaloy-2 alloys [6]. Samples for characterization were sectioned from the block by electric discharge machining (EDM).

TABLE 3
Process Parameters for 3D Printing
Zircaloy-2 Block by LPBF

| Equipment | EOS M280 with a | |
|---|---|---|
| | 400 W Laser | |
| Powder type | Zircaloy-2 | |
| Powder size range | 40-60 | μm |
| Layer thickness | 40 | μm |
| Chamber gas | Argon | |
| Build plate | Zircaloy-4 | |
| Build time | 21 | hours |

Conventional Plates

Two 3.4 mm thick plates of recrystallized Zircaloy-2 were purchased from ATI Specialty Metals Inc. for use as comparison material. The chemical composition of the plates was similar to the powder and is reported in Table 2.

Various aspects of certain non-limiting embodiments the inventions encompassed by the present disclosure include, but are not limited to, the aspects listed in the following numbered clauses.
1. A method for additively manufacturing a component for use in a nuclear reactor, the method comprising:
   additively manufacturing the component for use in the nuclear reactor utilizing a feedstock comprising a metal; and,
   annealing the additively manufactured component at a first annealing temperature within the alpha phase temperature range, the alpha+beta phase temperature range of the metal, or a combination thereof.
2. The method of clause 1, wherein the first annealing temperature is within the alpha phase temperature range of the metal and the method further comprises annealing the additively manufactured component for a second time at a second annealing temperature within the alpha+beta phase temperature range of the metal.
3. The method of any one of clauses 1-2 wherein the metal comprises a zirconium alloy.
4. The method of any one of clauses 1-3 wherein the metal comprises Zircaloy-2, Zircaloy-4, HiFi™, a binary zirconium alloy, or a non-binary zirconium alloy comprising tin and another alloying element, or a combination thereof.
5. The method of any one of clauses 1-3 wherein the metal comprises ZIRLO, Optimized ZIRLO, AXIOM, a binary zirconium alloy comprising niobium, or a non-binary zirconium alloy comprising niobium and another alloying element, or a combination thereof
6. The method of any one of clauses 1-5 further comprising annealing the additively manufactured component for a second time at a second annealing temperature that is lower than the first annealing temperature.
7. The method of any one of clauses 1-6 wherein feedstock comprises powder, a sheet, or a wire, or combinations thereof.
8. The method of clause 1-3 and 5-7 wherein the metal comprises a zirconium alloy comprising niobium and the first annealing temperature is in a range of 600° C. to 800° C. and the second annealing temperature is in a range of 450° C. to 600° C.
9. The method of clause 8 wherein the second annealing temperature is in a range of 530° C. to 580° C.
10. The method of any one of clauses 1-9 wherein the first annealing temperature recrystallizes a microstructure of the additively manufactured component.
11. The method of clause 10 wherein the metal comprises an alloy comprising a matrix of a primary phase metal and a second-phase metal, and the second annealing temperature achieves a composition and size distribution for the second-phase metal suitable for use in a nuclear reactor.
12. The method of any one of clauses 1-11 wherein the additive manufacturing process comprises powder bed fusion, vat photo-polymerization, binder jetting, material extrusion, directed energy deposition, material jetting, or sheet lamination, or a combination thereof.
13. A method for additively manufacturing a component for use in a nuclear reactor comprising:
   depositing a layer of a powder feedstock comprising a zirconium alloy, across a build plate;
   affixing at least a selected region of the layer together in the selected region, the affixing comprising:
      rastering a laser across the layer of powder feedstock along a path guided by previously input computer-aided design files of the specifications for a three-dimensional component to be built;
      melting the powder feedstock within the layer with the laser;
      solidifying the melted powder;
   repeating the depositing and the affixing to provide an additively manufactured component;
   removing the additively manufactured component from the build plate;
   annealing the additively manufactured component at an annealing temperature within the alpha phase temperature range of the metal, the alpha-beta phase temperature range of the metal, or a combination thereof.
14. The method of clause 13, wherein the metal comprises Zircaloy-2, Zircaloy-4, HiFi™ a non-binary zirconium alloy comprising tin and another alloying element, ZIRLO, Optimized ZIRLO, AXIOM, a binary zirconium alloy comprising niobium, or a non-binary zirconium alloy comprising niobium and another alloying element, or a combination thereof
15. The method of any one of clauses 13-14, wherein the annealing temperature is within the range of 450° C. to 800° C.
16. The method of any one of clauses 13-15 wherein the alloy comprises a zirconium alloy comprising niobium and the annealing temperature is within the range of 450° C. to 620° C.
17. The method of any one of clauses 13-16 wherein the annealing occurs for a time period ranging from 0.1 hour to 100 hours.
18. The method of any one of clauses 13-17 wherein the component comprises a debris filter, an intermediate flow mixer, a spacer grid, or a combination thereof.
19. The method of any one of clauses 13-18 wherein the powder feedstock comprises a mean average particle size in a range of 10 micrometers to 100 micrometers.
20. The method of any one of clauses 13-15 and 17-19 wherein the annealing temperature is in a range of 740° C. to 780° C. and the annealing occurs for a time period of in a range of 1 hour to 3 hours.

Conventional Zircaloy-2 plates made by Sandvik were included in select autoclave corrosion tests (described later). One type was processed in the recrystallized condition while the other was beta-quenched (BQ) after recrystallization. The beta quench was done to randomize the texture to minimize the dimension changes due to irradiation growth. Chemistry of the fully recrystallized (RXA) and BQ/RXA plates are reported in Table 2. Additional details can be found in Dahlbäck, M., et al., “The Effect of Beta-Quenching in Final Dimension on the Irradiation Growth of Tubes and Channels.” Zirconium in the Nuclear Industry: Fourteenth International Symposium, STP 1467, B. Kammenzind and P. Rudling Eds., ASTM International, West Conshohocken, Pa., 2005, pp. 276-304.

Characterization Techniques

### Density

Immersion density measurements were performed using a Mettler Toledo XXP Precision balance with an immersion density kit with deionized water. NIST traceable calibrated weights were used to check the precision balance and a pure titanium rod was used to check the density calculating software built into the equipment. The calculations were based on [5]. Measurements were made on unirradiated full intact quads. Ten wet and dry measurements were made on each quad and the results were averaged.

Void fraction measurements were also performed on the metallurgical mounts of the cross-sectioned additively manufactured materials (described later). The void fraction was digitally measured and percent theoretical density was 100% minus the void fraction.

Crystallographic Texture

Crystallographic texture of an additively manufactured block sample was measured by a direct pole figure technique [7]. A sample was polished to create a flat surface for measurement while removing any residual EDM layer. The piece was then light pickled with 45H₂O-45HNO₃:10HF solution to remove any cold work introduced to the surface by polishing. The sample was analyzed.

Complete pole figures were obtained from the orientation distribution function (ODF). The ODF was calculated using texture analysis software popLA [8, 9]. Input to the program was data from the following partial pole figure:

(101̅0), (0002), (101̅1), (112̅0), and (101̅3).

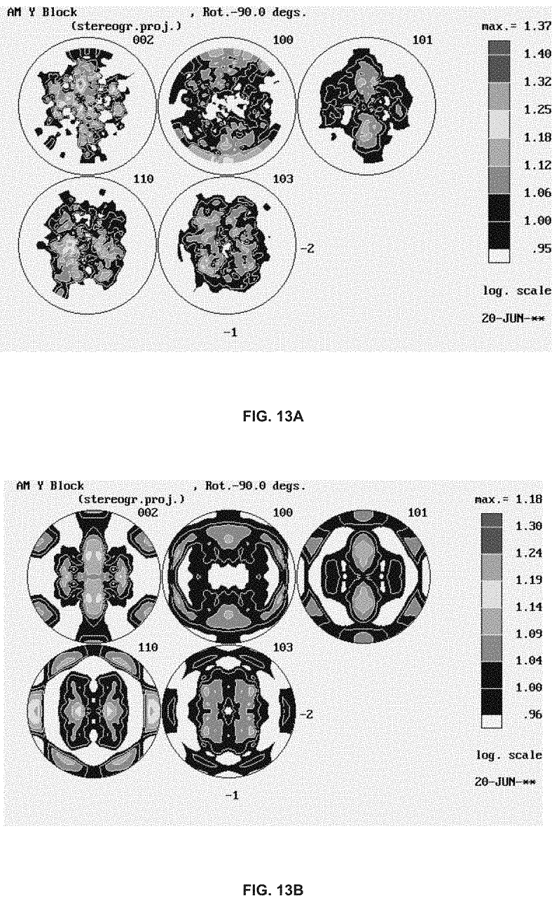

The texture parameters for the three orthogonal directions ((a)normal, (b)transverse, and (c) longitudinal) were calculated from the complete pole figure (See FIGS. 13A and 13B).

The texture parameters for the three orthogonal directions (normal, transverse, and longitudinal) were calculated from the complete pole figure. The calculated texture parameters are tabulated for the basal pole and were renamed based on the three block directions X, Y and Z where Z is the build direction.

Microstructure

Specimens were selected for metallurgical mounting; light optical microscopy (LOM) and scanning electron microscopy (SEM) evaluation. One sample from each direction (X, Y, and Z) of the unirradiated additively manufactured materials and the conventional ATI plate material were cross-sectioned.

In many cases, few features could be discerned in the unirradiated specimens in the as-polished condition. Therefore, a light etch consisting of 45H₂O:45HNO₃:5HF was used to bring out the grain structures of the cross-sections. Swabbing was kept to 5-10 seconds to reduce material pitting.

Mechanical Testing

Microhardness

Microhardness measurements were made on the as-polished surfaces with a Wilson Instruments Tukon 2100B tester [10]. A Vickers indenter was used with a 50X objective, a 500 gram-force load and 10 seconds dwell time. Traces were made within the center region of the mounted samples.

Corrosion Testing

Oxidation

Steam corrosion tests in autoclaves were performed on select unirradiated Zircaloy-2 specimens. Testing was performed at 427° C. and a pressure of 10.3 MPa according to ASTM G2 [13]. The samples were weighed after select time intervals and the mass gain was calculated and recorded.

Hydrogen

All hydrogen measurements were performed on a LECO RHEN 602 analyzer. Measurements were made following the short term autoclave testing. All samples were cleaned with acetone and weighed prior to analysis.

Results

Density and Chemistry

Initial assessment the Zircaloy-2 block included density and chemistry to confirm that additive manufacturing could produce material that was fully dense with no significant chemistry changes from the starting powder.

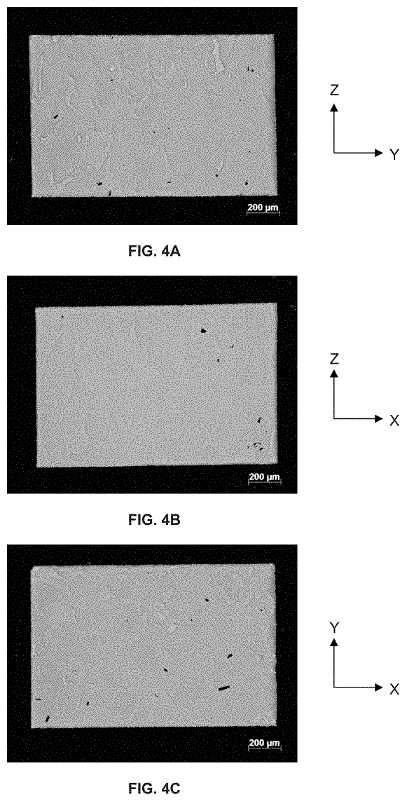

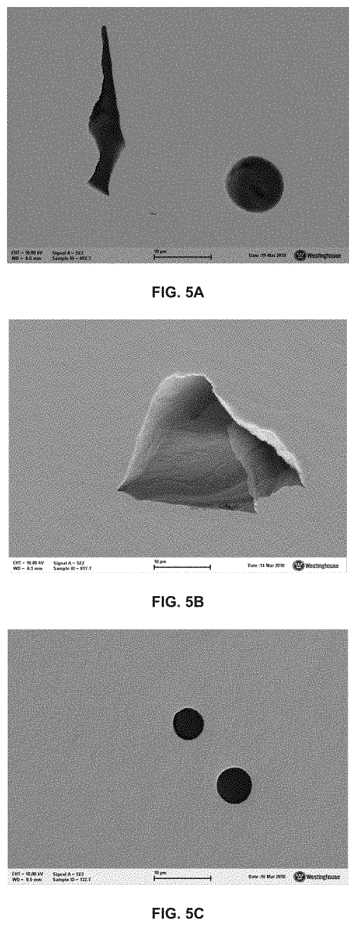

Density determined by both immersion and metallography are summarized in Table 5. Using the RXA Zircaloy-2 plate as the reference for 100% dense material, the immersion technique showed the additively manufactured material to be 99.9% dense. Metallography performed on additively manufactured samples confirmed the high density. Polished cross-sections from the gage section of mini-tensile samples (see FIGS. 4A-4C) revealed an area fraction of voids of about 0.1% that corresponds to a density 99.9%. The voids were isolated in the interior of the specimen and consisted of both irregularly shaped pores due to incomplete melting of the powder or spherical voids from trapped gas as shown in FIGS. 5A-C.

TABLE 5
Density of Zircaloy-2 by Immersion and Metallography

| | | Immersion | | | | Metallography | |
|---|---|---|---|---|---|---|---|
| Sample | | g/cm³ | | Percent | | Percent | |
| Zircaloy-2 Plate | | 6.5265 | | 100.0% | | — | — |
| Additively | X | 6.5249 | 6.5214 | 100.0% | 99.9% | 99.9% | 99.9% |
| Manufactured | Y | 6.5219 | | 99.9% | | 100.0% | |
| Quad | Z | 6.5175 | | 99.9% | | 99.9% | |

The major alloying additions of (Sn, Fe, Cr, and Ni) all remained well within the broad ASTM specification for Zircaloy-2 [6]. The oxygen content of the powder was 1600 wPPM and higher than the more typical value of 1200 wPPM. In addition, the nitrogen content of the powder was high and above the ASTM maximum of 80 wPPM nitrogen. It is not known if the high oxygen and nitrogen contents of the powder were due to high values in the starting material used to make the powder or to pick up during the process of making the powder. Despite the high values of oxygen and nitrogen in the powder, the composition of the block showed only minor pick up of additional oxygen and no further pick up of nitrogen. The hydrogen content in the block is noted to be higher than the ASTM maximum of 25 wPPM hydrogen though the source of the high hydrogen is not known.

Texture

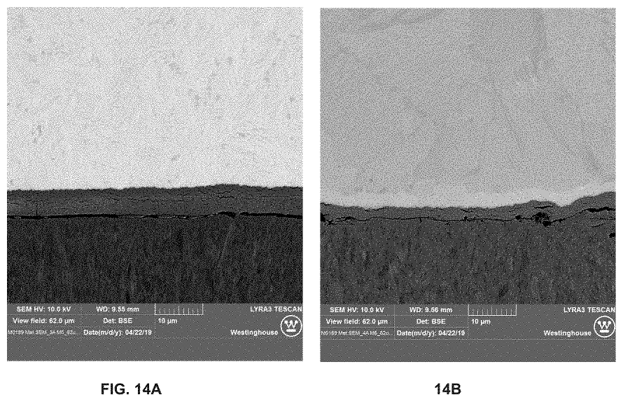

Measurement of the crystallographic texture revealed the additively manufactured material to be isotropic (See FIGS. 14A and 14B). The texture parameters in the three orthogonal directions (X, Y, and Z) in Table 6 were close to 0.333, which is indicative of a random texture. Included in the table for comparison are the texture parameters for conventionally-processed Zircaloy-2 plate which was produced by multiple iterations of rolling and annealing. The values are representative of conventionally processed material and result from the hexagonal alpha phase crystal structure.

TABLE 6
Texture Parameters of Zircaloy-2 Materials

| Specimen | Process | Orientation | Texture Parameter |
|---|---|---|---|
| Zircaloy-2 | Additive | X | 0.321 |
| | Manufacturing | Y | 0.330 |
| | | Z | 0.348 |
| Zircaloy-2 plate | RXA/Sandvik | Norm. | 0.659 |
| | | Trans. | 0.262 |
| | | Long. | 0.079 |

Microstructure

Low magnification optical micrographs of the additively manufactured block were taken in the three orthogonal directions with Z being the build direction. FIGS. 4A and 4B are surfaces normal to the X and Y directions, respectively. As can be seen in the micrographs, the large grains are elongated along the Z (build) direction. The grains are equiaxed when looking down the Z axis as shown in FIG. 4C. This structure is the result of the localized melting of each sequential powder layer by the laser beam.

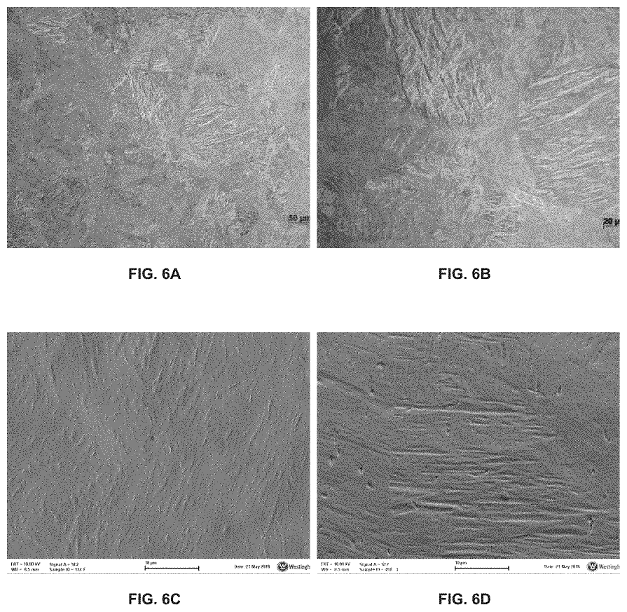

Higher magnification optical and SEM images of the additively manufactured Zircaloy-2 block are shown in FIGS. 6A-6D. A beta-quenched microstructure is shown consisting of very fine (<1 μm) alpha phase lathes [14]. The presence of the solid Zircaloy-2 below each layer of Zircaloy-2 powder provides a heat sink for very rapid cooling as the melt solidifies as beta phase and then transforms to alpha phase. Microstructures with cooling rates from the beta phase above 500 K/sec. to 1000 K/sec. [15, 16], are typically described as martensitic. While the cooling rate during the additively manufactured build of the Zircaloy-2 block was not measured, the very fine microstructure is consistent with a martensitic structure.

Mechanical Properties

Microhardness

Vickers microhardness results are tabulated in Table 7. Load directions were perpendicular to the polished surface.

TABLE 7
Zircaloy-2 Vickers Microhardness (HV)

| | | Microhardness | |
|---|---|---|---|
| Sample and Load Direction | | Avg. HV (SD) | |
| Zircaloy-2 Plate | T | 188 (8) | |
| (RXA/ATI) | L | 170 (4) | |
| Additively | X | 263 (6) | 261 (5) |
| Manufactured | Y | 258 (5) | |
| Zircaloy-2 | Z | 260 (2) | |
| 1-cycle Additively | X | 307 (4) | 306 (5) |
| Manufactured Zircaloy-2 | Y | — | |
| Quad (0.9 dpa) | Z | 306 (5) | |
| 2-cycle Additively | X | — | 324 (8) |
| Manufactured Zircaloy-2 | Y | 320 (8) | |
| Quad (1.6 dpa) | Z | 327 (6) | |

| | | |
|---|---|---|
| Annealed Additively | Y | 204 (11) |
| Manufactured Zircaloy-2 | | |
| (760° C./2 h) | | |

There were differences in microhardness between the longitudinal and transverse directions for the conventional RXA material. The average microhardness was slightly higher in the transverse orientation (188 HV) versus the longitudinal orientation (170 HV). These differences are due to the crystallographic texture of the material. These values are within the typical range for fully RXA zirconium material.

The additively manufactured Zircaloy-2 quads had similar measurements in all three directions. The average microhardness of the three directions is 261 HV. This material is harder than the conventional material and isotropic. After annealing at 760° C./2 h, the hardness of the AM Zircaloy-2 dropped significantly to 207 and is consistent with the recrystallization of the material.

Fractography

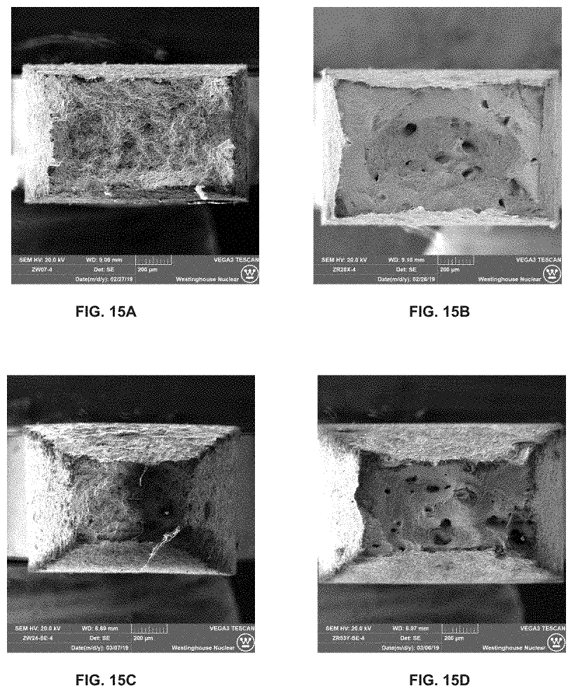

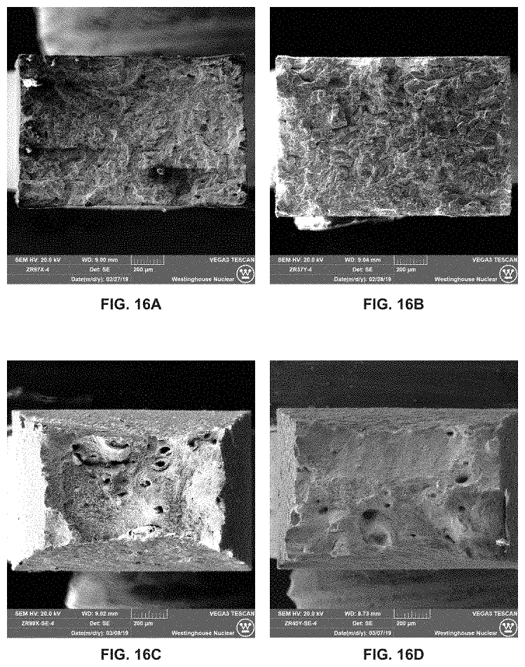

Comparison images between the room temperature (RT) tensile fractures and elevated temperature fractures (573 K) are provided in FIGS. 15A-15D and 16A-16D. The conventional material was quite ductile and many uniform cellular features were shown over the entire fracture face (See FIGS. 15A and 15C). Large isolated pores were observed in the unirradiated RT additively manufactured material that seemed to be uniformly distributed within the fracture face (See FIG. 15B). The pores ranged in size from 20-80 micrometers. Ductile regions were also found in the fracture surface. There were more dimple-like ductile regions in the elevated tensiles (See FIGS. 15C and 15D). Pores were also present in the elevated temperature additively manufactured tensiles and were similar in size to the observed in the RT additively manufactured tensiles (See FIG. 15D).

The irradiated fracture surfaces were a stark contrast to the unirradiated additively manufactured material (See FIGS. 16A and 16B). Pores were found, but were much smaller in diameter (less than 20 micrometers). Less reduction in area was noted on the irradiated samples with increasing dose. Ductile regions were noted at the outer perimeter of the fracture faces for the elevated temperature irradiated samples (See FIGS. 16C and 16D). Despite the reduction in elongation, it appears that the additively manufactured Zircaloy-2 retained the ability to deform locally in the plastic regime rather than by brittle fracture. This is consistent to what has been observed in conventional Zircaloy-2 materials [18].

Corrosion

Optimizing the corrosion performance of additively manufactured material was beyond the scope of the initial exploratory study. However, a limited effort was performed to assess the impact of annealing on corrosion. Additively manufactured coupons were prepared by grinding the surfaces on silicon carbide paper to remove the recast layer that was present due to the EDM process. Two coupons were annealed at 760° C. for 2 hours to precipitate and coarsen the second phase particles (SPPs). The two annealed coupons along with two as-ground coupons were cleaned and autoclave tested in 427° C./10.3 MPa steam.

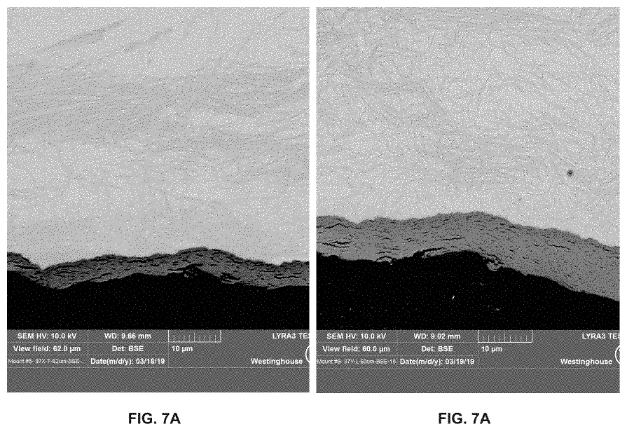

Weight gain results from the autoclave test are given in Table 1 and cross-sections of the oxide are shown in FIGS. 7A-7B. Oxide cross-sections of both as-printed and annealed additively manufactured material are shown in FIGS. 7A and 7B. Also included in Table 10 are the weight gains from Zircaloy-2 plate produced by conventional processing as well as Zircaloy-2 plate given a beta anneal followed by convective cooling. Since the EDM surface was removed from the autoclave samples prior to testing, the autoclave results reflect the impact of the additively manufactured sample microstructure. As previously described, the additive manufacturing process produced a beta-quenched microstructure in the material following the rapid solidification of the localized melt pool produced by the laser beam. While this anneal was intended to nucleate and coarsen SPPs, it also recrystallized the beta-quenched microstructure as shown in FIGS. 7A and 7B. The anneal resulted in a significant reduction in oxidation in the short-term steam test with the weight gain decreasing from an average of 145 mg/dm² to about 50 mg/dm². The weight gain of the annealed samples was in the same range as the conventionally-processed material.

Hydrogen pickup of the additively manufactured material normalized to a coupon thickness of 0.5 mm is also reported in Table 1 along with the pickup normalized to a coupon thickness of 0.5 mm. The percent theoretical hydrogen pickup was 24% for the additive manufacturing material in both the as-fabricated and annealed conditions.

Discussion

An exploratory program was initiated to assess of viability of applying additive manufacturing to the fabrication of zirconium alloy components for application in light water nuclear reactors. The focus of the program was to demonstrate that zirconium alloy material could be made by additively manufactured and to characterize mechanical properties in the as-fabricated condition and following short term irradiation. Additional work was performed to identify options to improve the corrosion performance of AM material and is the focus of this application.

The as-fabricated material was nearly 100% dense with minimal chemistry change between the starting powder and final material. The microstructure was martensitic and consisted of a fine lathe spacing resulting from the rapid quench from the melt. As expected, the texture was random with texture parameters in three orthogonal directions being close to 0.333. The room temperature tensile properties showed higher yield/ultimate stress and lower elongation than conventionally-processed Zircaloy-2 in the recrystallized condition. The increased strength is likely due to the martensitic microstructure as well as higher oxygen content in the additively manufactured material (1700 wPPM versus 1200 wPPM). A higher ultimate stress was also observed at 573 K. These mechanical properties are consistent with the higher hardness of the additively manufactured material. The hardness was also isotropic, which was consistent with the random texture. Finally, the yield and ultimate stresses increased, and elongation decreased with increasing irradiation dose from 0 to 0.9 to 1.6 dpa.

Since additive manufacturing is intended to produce final size components with no further mechanical deformation, annealing is the only option for post processing. Following the removal of EDM recast layer from the surface, coupons were annealed high in the alpha phase region with the goal of nucleating and growing SPPs.

An annealing parameter (A) was previously developed to characterize the thermal processing of material following the beta quench [19, 20, 21, 22].
A=t e^{(-Q/RT)}
Where
t=annealing time, h
T=annealing temperature, K
Q=activation energy and
R=molar gas constant

Target A parameters for PWR (Zircaloy-4) and BWR (Zircaloy-2) applications are given in Table 8.

TABLE 8
A Parameter for Additively Manufactured Anneal Compared
to Target A Parameters for PWR and BWR Applications

| | Reactor Type | |
|---|---|---|
| Parameter | PWR | BWR |
| Alloy | Zircaloy-4 | Zircaloy-2 |
| Q/R | 40,000K | 31,700K |
| Target A | 1 × 10⁻¹⁷ h | 0.6 × 10⁻¹⁵ h |
| A for Additive | 3 × 10⁻¹⁷ h | 9.4 × 10⁻¹⁴ h |
| Manufacturing Anneal | | |
| (2 h at 1033K) | | |

As this was an exploratory study, an annealing temperature high in the alpha temperature range (1033 K) and a reasonable process time (2 hours) were selected for the additively manufactured Zircaloy-2 material. The A-parameters for this anneal is given in Table 8 and compared to the target A-parameters for PWR and BWR applications. The additive manufacturing anneal is close to the PWR target and over an order of magnitude higher than the target for BWR. This comparison is provided only as a crude assessment of the potential impact of the anneal on SPPs as annealing a martensitic (additively manufactured) structure is significantly different than conventionally processed material.

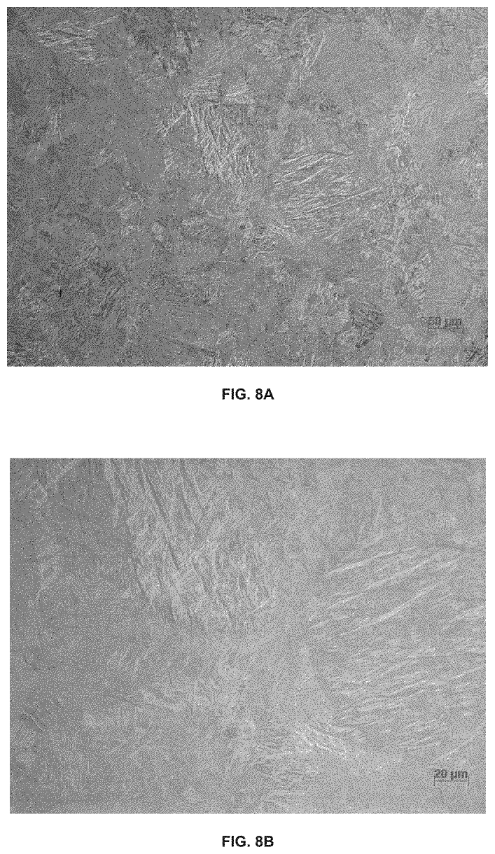

The result of the anneal was a recrystallized microstructure and a significant improvement in short term steam corrosion (see a comparison of FIGS. 8A-8B and 9A-9B). The recrystallized microstructure (See FIGS. 9A and 9B) is bimodal with both large and small alpha grains. Prior work has shown such microstructures with exaggerated grain growth following small plastic deformations (e.g., 3% to 10%) [23, 24]. Unlike the prior experience, the additively manufactured material was not deformed prior to the anneal. Apparently, the large stresses in the material from the rapid solidification and cooling to a martensitic microstructure provided the driving force for recrystallization.

The recrystallization of the additively manufactured material following the high temperature alpha anneal provides the following performance benefits:
Short term steam corrosion weight gains are comparable to conventionally-processed material and suggest that adequate in-reactor corrosion resistance of additively manufactured material may be achievable.
It is speculated that the recrystallized additively manufactured microstructure will have a random texture given the random texture in the martensitic additively manufactured material. The random texture should result in minimal in-reactor irradiation growth.

These experiments have shown the potential of applying additive manufacturing to the fabrication of zirconium alloy components. An approach to achieving adequate corrosion resistance of zirconium alloys is provided along with the potential of minimizing irradiation induced growth.

Conclusions

Zircaloy-2 block material was successfully fabricated from Zircaloy-2 powder by laser powder bed fusion. While the laser powder bed fusion method of additive manufacturing was used in the experiments, other additive manufacturing methods, particularly those suitable for use with metals and metal alloys may be substituted. Nearly full density was achieved (99.9%) with minor porosity consisting of spherical and irregularly-shaped voids. Only minor changes in material chemistry between the powder and the block were observed.

The nitrogen content was higher in additive manufacturing (85 PPM) than conventional Zircaloy-2 material (22 PPM) and will be reduced in the powder (110 PPM).

The bulk hydrogen in the as-fabricated additively manufactured Zircaloy-2 block was higher (33 PPM) than conventional ATI plate (4 PPM). A reduction of hydrogen in the starting powder may be beneficial.

The crystallographic texture of the additive manufacturing block material was isotropic. The hardness was also isotropic, which was consistent with the random texture.

The microstructure of the additively manufactured Zircaloy-2 was beta-quenched with fine alpha phase laths, consistent with a rapid quench from the melt.

A limited effort was performed to assess the impact of annealing on corrosion in additively manufactured Zircaloy-2. An annealing temperature high in the alpha temperature range was selected. The anneal provided a recrystallized microstructure and a significant improvement in short-term steam corrosion. Large stresses in the material from the rapid solidification and cooling to a martensitic microstructure aided in recrystallization of the additively manufactured material.

Various aspects of certain non-limiting embodiments the inventions encompassed by the present disclosure include, but are not limited to, the aspects listed in the following numbered clauses.
1. A method for additively manufacturing a component for use in a nuclear reactor, the method comprising:
   additively manufacturing the component for use in the nuclear reactor utilizing a feedstock comprising a metal; and,
   annealing the additively manufactured component at a first annealing temperature within the alpha phase temperature range, the alpha+beta phase temperature range of the metal, or a combination thereof
2. The method of clause 1, wherein the first annealing temperature is within the alpha phase temperature range of the metal and the method further comprises annealing the additively manufactured component for a second time at a second annealing temperature within the alpha+beta phase temperature range of the metal.
3. The method of any one of clauses 1-2 wherein the metal comprises a zirconium alloy.
4. The method of any one of clauses 1-3 wherein the metal comprises Zircaloy-2, Zircaloy-4, HiFi™, a binary zirconium alloy, or a non-binary zirconium alloy comprising tin and another alloying element, or a combination thereof.
5. The method of any one of clauses 1-3 wherein the metal comprises ZIRLO, Optimized ZIRLO, AXIOM, a binary zirconium alloy comprising niobium, or a non-binary zirconium alloy comprising niobium and another alloying element, or a combination thereof.
6. The method of any one of clauses 1-5 further comprising annealing the additively manufactured component for a second time at a second annealing temperature that is lower than the first annealing temperature.
7. The method of any one of clauses 1-6 wherein feedstock comprises powder, a sheet, or a wire, or combinations thereof.
8. The method of clause 1-3 and 5-7 wherein the metal comprises a zirconium alloy comprising niobium and the first annealing temperature is in a range of 600° C. to 800° C. and the second annealing temperature is in a range of 450° C. to 600° C.
9. The method of clause 8 wherein the second annealing temperature is in a range of 530° C. to 580° C.
10. The method of any one of clauses 1-9 wherein the first annealing temperature recrystallizes a microstructure of the additively manufactured component.
11. The method of clause 10 wherein the metal comprises an alloy comprising a matrix of a primary phase metal and a second-phase metal, and the second annealing temperature achieves a composition and size distribution for the second-phase metal suitable for use in a nuclear reactor.
12. The method of any one of clauses 1-11 wherein the additive manufacturing process comprises powder bed fusion, vat photo-polymerization, binder jetting, material extrusion, directed energy deposition, material jetting, or sheet lamination, or a combination thereof
13. A method for additively manufacturing a component for use in a nuclear reactor comprising:
   depositing a layer of a powder feedstock comprising a zirconium alloy, across a build plate;
   affixing at least a selected region of the layer together in the selected region, the affixing comprising:
      rastering a laser across the layer of powder feedstock along a path guided by previously input computer-aided design files of the specifications for a three-dimensional component to be built;
      melting the powder feedstock within the layer with the laser;
      solidifying the melted powder;
   repeating the depositing and the affixing to provide an additively manufactured component;
   removing the additively manufactured component from the build plate;
   annealing the additively manufactured component at an annealing temperature within the alpha phase temperature range of the metal, the alpha-beta phase temperature range of the metal, or a combination thereof.
14. The method of clause 13, wherein the metal comprises Zircaloy-2, Zircaloy-4, HiFi™ a non-binary zirconium alloy comprising tin and another alloying element, ZIRLO, Optimized ZIRLO, AXIOM, a binary zirconium alloy comprising niobium, or a non-binary zirconium alloy comprising niobium and another alloying element, or a combination thereof.
15. The method of any one of clauses 13-14, wherein the annealing temperature is within the range of 450° C. to 800° C.
16. The method of any one of clauses 13-15 wherein the alloy comprises a zirconium alloy comprising niobium and the annealing temperature is within the range of 450° C. to 620° C.
17. The method of any one of clauses 13-16 wherein the annealing occurs for a time period ranging from 0.1 hour to 100 hours.
18. The method of any one of clauses 13-17 wherein the component comprises a debris filter, an intermediate flow mixer, a spacer grid, or a combination thereof.
19. The method of any one of clauses 13-18 wherein the powder feedstock comprises a mean average particle size in a range of 10 micrometers to 100 micrometers.
20. The method of any one of clauses 13-15 and 17-19 wherein the annealing temperature is in a range of 740° C. to 780° C. and the annealing occurs for a time period of in a range of 1 hour to 3 hours.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative embodiments. The embodiments described herein are understood as providing illustrative features of varying detail of various embodiments of the disclosed invention; and therefore, unless otherwise specified, it is to be understood that, to the extent possible, one or more features, elements, components, constituents, ingredients, structures, modules, and/or aspects of the disclosed embodiments may be combined, separated, interchanged, and/or rearranged with or relative to one or more other features, elements, components, constituents, ingredients, structures, modules, and/or aspects of the disclosed embodiments without departing from the scope of the disclosed invention. Accordingly, it will be recognized by persons having ordinary skill in the art that various substitutions, modifications or combinations of any of the exemplary embodiments may be made without departing from the scope of the invention. In addition, persons skilled in the art will recognize, or be able to ascertain using no more than routine experimentation, many equivalents to the various embodiments of the invention described herein upon review of this specification. Thus, the invention is not limited by the description of the various embodiments, but rather by the claims.

### CITATIONS

[1] J. H. Schemel, “ASTM Manual on Zirconium and Hafnium.” ASTM STP 639, American Society for Testing and Materials, Philadelphia, 1977.
[2] Sahasrabudhe, H. and Bandyopadhyay, A. “Laser-Based Additive Manufacturing of Zirconium,”Appl. Sci. 2018, 8, 393; doi: 10.3390/app8030393.
[3] Dahlbäck, M., Limbäck, M., Hallstadius, L., Barberis, P., Burnel, G., Simonot, C., Andersson, T., Askeljung, P., Flygare, J., Lehtinen, B., and Massih, A. R., “The Effect of Beta-Quenching in Final Dimension on the Irradiation Growth of Tubes and Channels.” Zirconium in the Nuclear Industry: Fourteenth International Symposium, STP 1467, B. Kammenzind and P. Rudling Eds., ASTM International, West Conshohocken, Pa., 2005, pp. 276-304.
[4] Walters, L., Douglas, S. R., and Griffiths, M. “Equivalent Radiation Damage in Zirconium Irradiated in Various Reactors,” Zirconium in the Nuclear Industry: Eighteenth International Symposium, STP 1597. R. J. Comstock and A. T. Motta Eds., ASTM International, West Conshohocken, Pa., 2018, pp. 676-690.
[5] Standard Test Method for Density of Powder Metallurgy (PM) Materials Containing Less Than Two Percent Porosity, ASTM B311-17 (2017) (West Conshohocken, Pa.: ASTM International, approved Apr. 1, 2017).
[6] Standard Specification for Zirconium and Zirconium Alloy Sheet, Strip, and Plate for Nuclear Applications, ASTM B352/B352M-17 (2017) (West Conshohocken, Pa.: ASTM International, approved May 1, 2017).
[7] Standard Test Method for Preparing Quantitative Pole Figures, ASTM E81-96 (2017) (West Conshohocken, Pa.: ASTM International, approved Jun. 1, 2017).
[8] Gale, B. and Griffiths, “Influence of Instrumental Aberrations on the Shultz Technique for the Measurement of Pole Figures,” Brit. J. Appl. Phys., 11, 96-102, (1960).
[9] “popLA, Preferred Orientation Package-Los Alamos,” Software Manual by S. I. Wright and U. F. Kocks, Los Alamos National Laboratory, Los Alamos, N. Mex.
[10] Standard Test Method for Microindentation Hardness of Materials, ASTM E384-17 (2017) (West Conshohocken, Pa.: ASTM International, approved Jun. 1, 2017).
[11] Standard Test Methods for Tension Testing of Metallic Materials, ASTM E8/E8M-16a (2016) (West Conshohocken, Pa.: ASTM International, approved Aug. 1, 2016).
[12] Standard Test Methods for Elevated Temperature Tension Tests of Metallic Materials, ASTM E21-17 (2017) (West Conshohocken, Pa.: ASTM International, approved Dec. 1, 2017).
[13] Standard Test Method for Corrosion Testing of Products of Zirconium, Hafnium, and Their Alloys in Water at 680° F. (360° C.) or in Steam at 750° F. (400° C.), ASTM G2/G2M-19 (2019) (West Conshohocken, Pa.: ASTM International, approved Jan. 1, 2019).
[14] Massih, A. R., Andersson, T., Witt, P., Dahlbäck, M., and Limbäck, M., “Effect of Quenching Rate on β-α Phase Transformation Structure in Zirconium Alloys,” Journal of Nuclear Materials, Vol. 322, 2003, pp. 138-151.
[15] Morize, P., Baicry, J., and Mardon, J. P., “Effect of Irradiation at 588 K on Mechanical Properties and Deformation Behavior of Zirconium Alloy Strip,” Zirconium in the Nuclear Industry: Seventh International Symposium, ASTM STP 939, R. B. Adamson and L. F. P. Van Swam, Eds., American Society for Testing and Materials, Philadelphia, 1987, pp. 101-119.
[16] Charquet, D. and Alheritiere, E., “Influence of Impurities and Temperature on the Microstructure of Zircaloy-2 and Zircaloy-4 after Beta→Alpha Phase Transformation,” Zirconium in the Nuclear Industry: Seventh International Symposium, ASTM STP 939, R. B. Adamson and L. F. P. Van Swam, Eds., American Society for Testing and Materials, Philadelphia, 1987, pp. 284-291.
[17] Garzarolli, F., Stehle, H., Steinberg, E., and Weidinger, H., “Progress in the Knowledge of Nodular Corrosion,” Zirconium in the Nuclear Industry: Seventh International Symposium, ASTM STP 939, R. B. Adamson and L. F. P. Van Swam, Eds., American Society for Testing and Materials, Philadelphia, 1987, pp. 417-430.
[18] C. L. Whitmarsh, “Review of Zircaloy-2 and Zircaloy-4 Properties Relevant to N. S. Savannah Reactor Design” ORNL Report ORNL-3281; UC-80-Reactor Technology, TID-4500 (17^{th} ed.) Tennessee, 1962.
[19] Steinberg, E., Weidinger, H. G., and Schaa, A., “Analytical Approaches and Experimental Verification to Describe the Influence of Cold Work and Heat Treatment on the Mechanical Properties of Zircaloy Cladding Tubes,” Zirconium in the Nuclear Industry: Sixth International Symposium, ASTM STP 824, D. G. Franklin and R. B. Adamson, Eds., American Society for Testing and Materials, 1984, pp. 106-122.
[20] Garzarolli, G., Steinberg, E., and Weidinger, H. G., “Microstructure and Corrosion Studies for Optimized PWR and BWR Zircaloy Cladding,” Zirconium in the Nuclear Industry: Eighth International Symposium, ASTM STP 1023, L. F. P. Van Swam and C. M. Eucken, Eds., American Society for Testing and Materials, Philadelphia, 1989, pp. 202-212.
[21] Tägstrom, P., et al., “Effects of Hydrogen Pickup and Second-Phase Particle Dissolution on the In-Reactor Corrosion Performance of BWR Claddings,” Zirconium in the Nuclear Industry: Thirteenth International Symposium, ASTM STP 1423, G. D. Moan and P. Rudling, Eds., ASTM International, West Conshohocken, Pa., 2002, pp. 96-118.
[22] Romero J., et al., “Evolution of Westinghouse fuel cladding”, in Proceedings of International Conference on Light Water Reactor Fuel Performance (Top Fuel 2014), Paper 100019. La Grange Park, Ill.: ANS, 2014.
[23] Tong, V. S. and T. B. Britton, “Formation of very large ‘blocky alpha’ grains in Zircaloy-4”, Acta Materialia, 129 (2017) 510-520.
[24] D. F. Washburn, “The formation of large grains in alpha Zircaloy-4 during heat treatment after small plastic deformations,” Knolls Atomic Power Laboratory, General Electric Company, Report KAPL-3062, New York, 1964.

What is claimed is:

1. A method for additively manufacturing a component for use in a nuclear reactor, the method comprising:
additively manufacturing the component for use in the nuclear reactor utilizing a feedstock comprising a metal; and,
annealing the additively manufactured component at a first annealing temperature within the alpha phase temperature range of the metal, the alpha+beta phase temperature range of the metal, or a combination thereof.

2. The method of claim 1, wherein the first annealing temperature is within the alpha phase temperature range of the metal and the method further comprises annealing the additively manufactured component for a second time at a second annealing temperature within the alpha+beta phase temperature range of the metal.

3. The method of claim 1 wherein the metal comprises a zirconium alloy.

4. The method of claim 1 wherein the metal comprises Zircaloy-2, Zircaloy-4, HiFi™, a binary zirconium alloy, or a non-binary zirconium alloy comprising tin and another alloying element, or a combination thereof.

5. The method of claim 1 wherein the metal comprises ZIRLO, Optimized ZIRLO, AXIOM, a binary zirconium alloy comprising niobium, or a non-binary zirconium alloy comprising niobium and another alloying element, or a combination thereof.

6. The method of claim 1 further comprising annealing the additively manufactured component for a second time at a second annealing temperature that is lower than the first annealing temperature.

7. The method of claim 1 wherein feedstock comprises powder, a sheet, or a wire, or combinations thereof.

8. The method of claim 6 wherein the metal comprises a zirconium alloy comprising niobium and the first annealing temperature is in a range of 600° C. to 800° C. and the second annealing temperature is in a range of 450° C. to 600° C.

9. The method of claim 8 wherein the second annealing temperature is in a range of 530° C. to 580° C.

10. The method of claim 1 wherein the first annealing temperature recrystallizes a microstructure of the additively manufactured component.

11. The method of claim 10 wherein the metal comprises an alloy comprising a matrix of a primary phase metal and a second-phase metal, and the second annealing temperature achieves a composition and size distribution for the second-phase metal suitable for use in a nuclear reactor.

12. The method of claim 1 wherein the additive manufacturing process comprises powder bed fusion, vat photo-polymerization, binder jetting, material extrusion, directed energy deposition, material jetting, or sheet lamination, or a combination thereof.

13. A method for additively manufacturing a component for use in a nuclear reactor comprising:
depositing a layer of a powder feedstock comprising a zirconium alloy, across a build plate;
affixing at least a selected region of the layer together in the selected region, the affixing comprising:
rastering a laser across the layer of powder feedstock along a path guided by previously input computer-aided design files of the specifications for a three-dimensional component to be built;
melting the powder feedstock within the layer with the laser;
solidifying the melted powder;
repeating the depositing and the affixing to provide an additively manufactured component;
removing the additively manufactured component from the build plate;
annealing the additively manufactured component at an annealing temperature within the alpha phase temperature range of the metal, the alpha-beta phase temperature range of the metal, or a combination thereof.

14. The method of claim 13, wherein the metal comprises Zircaloy-2, Zircaloy-4, HiFi™ a binary zirconium alloy comprising niobium, a non-binary zirconium alloy comprising tin and another alloying element, ZIRLO, Optimized ZIRLO, AXIOM, a binary zirconium alloy comprising niobium, or a non-binary zirconium alloy comprising niobium and another alloying element, or a combination thereof.

15. The method of claim 13, wherein the annealing temperature is within the range of 450° C. to 800° C.

16. The method of claim 13 wherein the alloy comprises a zirconium alloy comprising niobium and the annealing temperature is within the range of 450° C. to 620° C.

17. The method of claim 13 wherein the annealing occurs for a time period ranging from 0.1 hour to 100 hours.

18. The method of claim 13 wherein the component comprises a debris filter, an intermediate flow mixer, a spacer grid, or a combination thereof.

19. The method of claim 13 wherein the powder feedstock comprises a mean average particle size in a range of 10 micrometers to 100 micrometers.

20. The method of claim 13 wherein the annealing temperature is in a range of 740° C. to 780° C. and the annealing occurs for a time period of in a range of 1 hour to 3 hours.
